(19) United States
(12) Patent Application Publication
(10) Pub. No.: US 2008/0290226 A1
(43) Pub. Date: Nov. 27, 2008

(54) Keyboard/mouse hand pad with massage function

(76) Inventor: Chi-Pei Ho, Taipei Hsien (TW)

Correspondence Address: PRO-TECHTOR INTERNATIONAL SERVICES, 20775 NORADA CT., SARATOGA, CA, 95070, US

(21) Appl. No.: 11/807,094

(22) Filed: May 24, 2007

(51) Int. Cl. B68G 5/00; F16M 1/00

(52) U.S. Cl. 248/118; 248/562

(57) ABSTRACT

A keyboard/mouse hand pad with massage function, which includes a soft hand having outer peripheries completely covered with massage protuberances that provide a massage effect, and the entire interior is filled with massage pellets, which enable the hand pad to change in form when the wrist of a user is placed thereon, thereby providing both a comfortable and massage effect.

### BACKGROUND OF THE INVENTION

(a) Field of the Invention

The present invention provides a soft hand pad, outer peripheries of which are completely covered with massage protuberances, and the entire interior is filled with massage pellets. When the wrist of a user is placed on the hand pad, apart from the massage pellets enabling the hand pad to change in form as pressure from the wrist is varied, thereby providing comfort to the wrist. Moreover, the massage protuberances provide a massage effect.

(b) Description of the Prior Art

Referring to FIG. 1, which shows a traditional mouse pad, wherein a hand pad 101 protrudes from a front end of a pad 100, thereby enabling a user to place his wrist thereon to facilitate operating a mouse. Referring to FIG. 2, which shows a traditional keyboard pad 200, a protruding portion of which enables the wrist to be conveniently placed thereon, however, the aforementioned mouse pad or keyboard pad of prior art lacks provision of a massage effect. Moreover, such prior art pads are not able to change in form when the hand is placed thereon and pressure from the wrist is varied, and thus subject to improvement.

### SUMMARY OF THE INVENTION

A primary objective of the present invention is to provide a soft hand pad made from cloth, outer peripheries of which are completely covered with massage protuberance, and the entire interior of the pad is filled with massage pellets. When the wrist of a user is placed on the hand pad, the hand pad is able to change in form as pressure from the wrist is varied, thereby providing relative comfort to the user, and the covering massage protuberances enable achieving a massage effect.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an external view of a mouse pad of prior art.

FIG. 2 shows an external view of a keyboard pad of prior art.

FIG. 3 shows an external view of the present invention.

FIG. 4 shows a partial cutaway view the present invention.

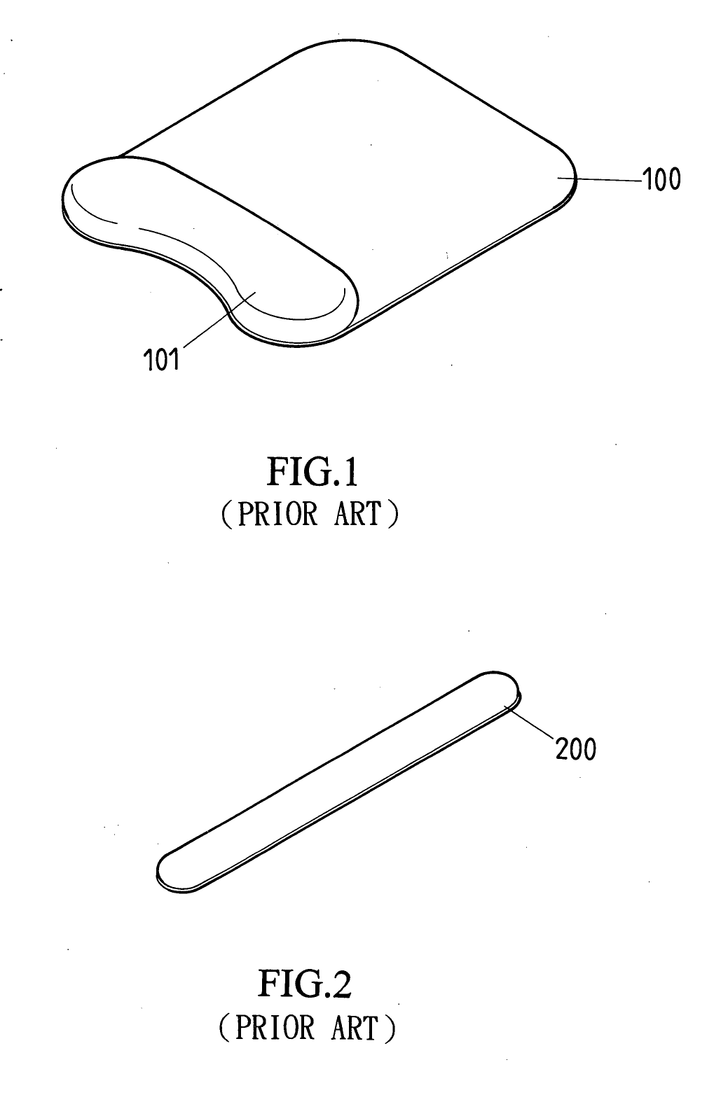

### DETAILED DESCRIPTION OF THE PREFERRED EMBODIMENTS

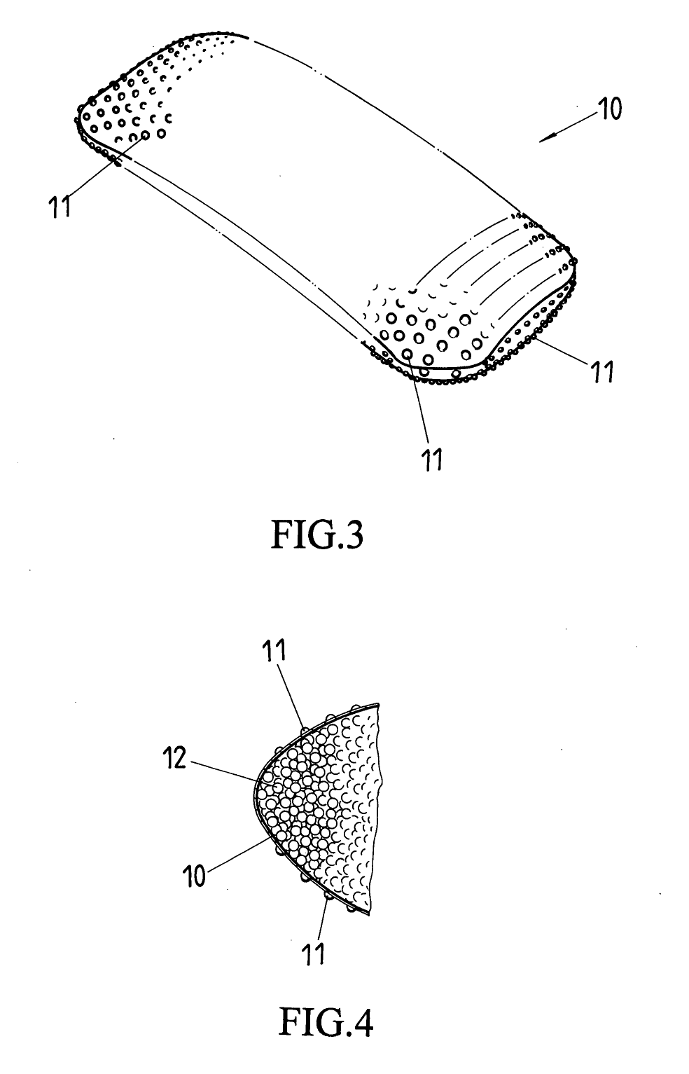

Referring to FIGS. 3 and 4, which show a keyboard/mouse hand pad of the present invention, wherein shape of the hand pad is rectangular, square, circular or other irregular shape. A pad 10 is made from soft material (such as cloth), and outer peripheries of the pad 10 are completely covered with massage protuberances 11 which are attached to the cloth pad 10 using a heat cycle molding method. The massage protuberances 11 provide a massage effect when the wrist of a user is placed on the pad 10. Furthermore, interior of the pad 10 is filled with a plurality of massage pellets 12 which spread as pressure from the wrist changes, thereby providing relative comfort to the wrist when placed on the pad 10.

As will be apparent from the foregoing, the massage protuberance 11 completely covering the outer peripheries of the soft and pliable but strong hand pad 10 of the present invention provide a massage effect for the wrist. Moreover, the massage pellets 12 filled interior of the pad 10 enables the pad 10 to have the behavior similar to a sandbag, whereby the pad 10 is able to change in form as pressure from the wrist is altered, which not only provides relative comfort to the wrist, but also provides the pad 10 with an auxiliary massage function.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A keyboard/mouse hand pad with massage function, comprising a soft pad, outer peripheries of which are completely covered with massage protuberances, and the interior of the pad is filled with a plurality of massage pellets.

2. The keyboard/mouse hand pad with massage function according to claim 1, wherein the entire body of the pad is made from cloth and fabricated to form a variety of shapes.
